(19) United States
(12) Patent Application Publication
(10) Pub. No.: US 2025/0325922 A1
(43) Pub. Date: Oct. 23, 2025

(54) Parallel Separation and Washing in Size Exclusion Chromatography Separation or in Desalting of a Target from a Sample

(71) Applicant: Cytiva Sweden AB, Uppsala (SE)

(72) Inventor: Christer Olof Eriksson, Uppsala (SE)

(21) Appl. No.: 19/207,047

(22) Filed: May 13, 2025

(30) Foreign Application Priority Data
Feb. 28, 2017 (GB) 1703258.2

(51) Int. Cl. B01D 15/18; B01D 15/34

(52) U.S. Cl. CPC B01D 15/1835; B01D 15/1842; B01D 15/34

(57) ABSTRACT

Systems and methods are provided for performing washing of columns in a simulated moving bed chromatography system while separation is being performed in the system.

### CROSS REFERENCE TO RELATED APPLICATIONS

This application is a continuation of U.S. application Ser. No. 16/486,629, filed Aug. 16, 2019, which claims the priority benefit of PCT/EP2018/054595, filed on Feb. 23, 2018, which claims priority benefit of Great Britain Application No. 1703258.2, filed on Feb. 28, 2017. The entire contents of which are hereby incorporated by reference herein

### FIELD OF THE INVENTION

The present invention relates to chromatography and more particularly to methods and systems for performing chromatography while simultaneously performing washing of one or more chromatography columns in a chromatography system comprising a plurality of columns. More specifically the invention relates to the parallel washing of a column in a simulated moving bed chromatography system while it is performing size exclusion chromatography (SEC) or desalting.

### BACKGROUND OF THE INVENTION

Size exclusion chromatography (SEC) separates molecules according to differences in size as they pass through a SEC medium in a column. SEC media consist of a porous matrix of spherical particles with chemical and physical stability and inertness (i.e. a lack of reactivity and adsorptive properties). To perform a separation, the medium is packed into a column to form a packed bed. The packed bed is equilibrated with buffer, which fills the pores of the matrix and the space between the particles. The liquid inside the pores, or stationary phase, is in equilibrium with the liquid outside the particles, or mobile phase. Small molecules enter the pores of the medium and are delayed, while large molecules which are too large to enter the medium pass through the column unobstructed. An example of the results of typical SEC run in which high molecular weight molecules leave a SEC column first and low molecular weight molecules leave the column last is shown in FIG. 2b). Thus, unlike ion-exchange or affinity chromatography, the molecules do not bind to the chromatography medium so buffer composition does not directly affect resolution (the degree of separation between peaks of the molecules leaving the column). Consequently, a significant advantage of SEC is that conditions can be varied to suit the type of sample or the requirements for further purification, analysis, or storage without altering the separation. The longer the column the better resolution as the smaller molecules are delayed for increasing longer times as the length of a column increases, however the column has a larger backpressure and there are practical limitations to how long a column can be. A method known as simulated moving bed (SMB) is used to overcome this problem this is achieved by dividing the total desired length of a column into a plurality of columns which are connected in series. The pressure drop is thereby reduced to a fraction of that which would have been experienced over a single column with the same total length as the plurality of columns. FIGS. 1a) and 1b) shows a theoretical comparison between the pressure drop dP over a system comprising one long column 1 of length L (shown in FIG. 1a)) compared to the pressure drop over a system comprising three identical columns A, B, C (shown in FIG. 1b)) which have the same total length and volume as the single column. Fluid is supplied to the top of column 1, respectively column A and is extracted from the base of column 1, respectively column 3. The extracted fluid passes through a detector D and then through a valve which can direct the fluid to a waste pathway W or to storage S. The valve is controlled by detector D-when detector D detects the presence of target molecules the valve can be controlled to deliver the fluid to waste or storage as appropriate. As can be clearly seen, the total length of columns A, B, C being the same as that of column 1, the theoretical pressure drop over each of the three columns A-C is only one third of that over the single column 1. However as only two columns need to be connected in series at any time (for example columns A and B as shown by the solid line, and columns B and C as shown by the dashed line) then the actual pressure drop during the chromatography run is 2/3 dP.

Samples are normally eluted isocratically so there is no need to use different buffers during the separation. However, a wash step (also known as washing-in-place (CIP)) using the running buffer or an alkaline solution is usually included at the end of a separation to remove molecules that might have been retained on the column and to prepare the column for a new run. Such a washing step takes time as the separation medium needs to be subjected to the washing fluid for a certain length of time, for example 10 minutes, and the column is unavailable for use until the washing step is completed.

### BRIEF DESCRIPTION OF THE INVENTION

In one aspect the present invention relates to a chromatography system comprising a plurality of substantially identically packed size exclusion chromatography columns for use in a method according to the invention.

In another aspect the present invention provides a method of operating a size exclusion chromatography system in which separation can take place in parallel with a wash step.

### BRIEF DESCRIPTION OF THE FIGURES

FIG. 1A shows schematically a single column.

FIG. 1B shows schematically a system comprising a plurality of columns, arranged in series, with the same total length as the column in FIG. 1A.

FIG. 2A shows a typical graph of absorption of UV-light with a wavelength of 280 nm against time for a SEC run in a SEC column, respectively conductivity against time for a desalting run in a desalting column.

FIG. 2B shows a typical graph of absorbance against column volumes passed through a SEC column.

FIG. 3A shows schematically an example of a SEC or desalting system in accordance with the present invention.

FIG. 3B shows a schematic enlarged view of the multi-position valve of FIG. 3a).

FIGS. 4-7 show steps in a method according to the present invention comprising a plurality of cycles using the system of FIG. 3.

FIGS. 8-11 show steps in another method according to the present invention comprising a plurality of cycles using the system of FIG. 3.

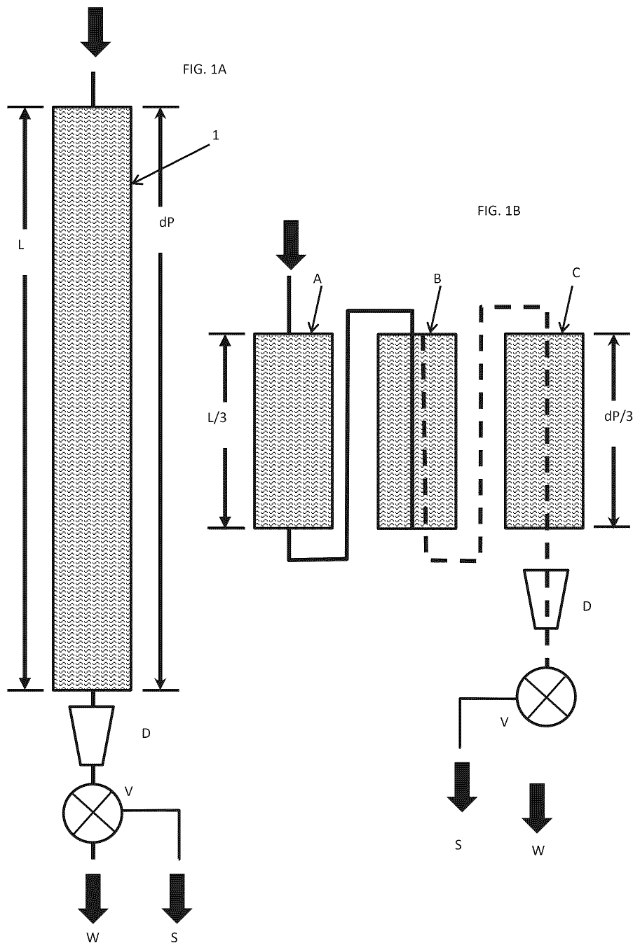

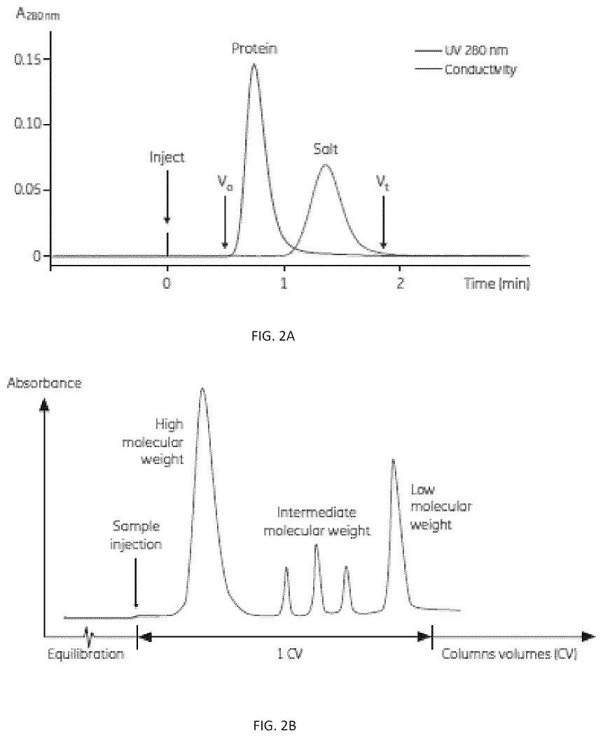

### DETAILED DESCRIPTION OF THE INVENTION

The present invention relates to a method of using size exclusion chromatography to separate at least one target molecule or group of target molecules (called simply “target” in the following for brevity) from a sample in a simulated moving bed chromatography system (SMB system) comprising a plurality of SEC medium-containing columns, in which during the separation process at least one medium-containing column in the system is washed.

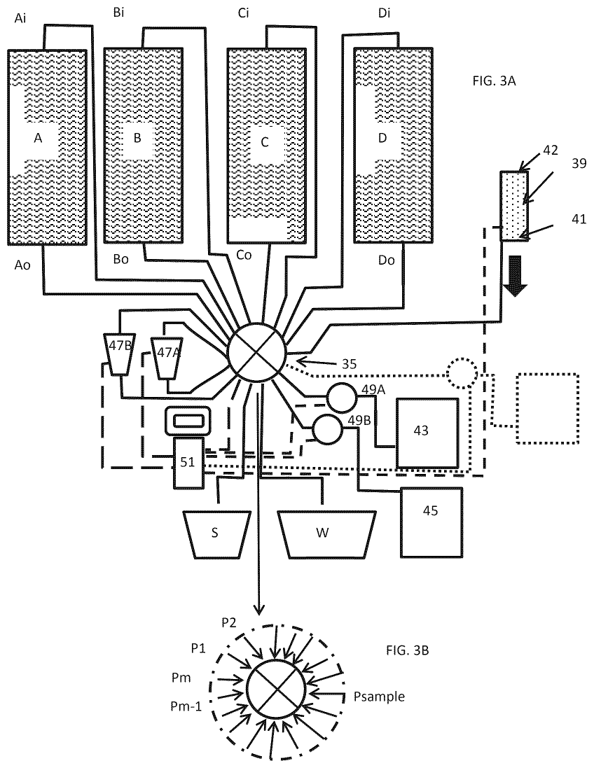

One embodiment of such a system is shown schematically in FIG. 3. The system 30 comprises, in this embodiment, four chromatography columns A, B, C, D. Each column contains a separation medium (33). Preferably the columns have substantially identical performance and preferably the same separation medium and packing protocol is used in every column. Having substantially identical columns ensures that the result of a chromatography cycle is independent on which order the columns are used in. Each column follows convention and has an inlet Ai, Bi, Ci, Di at one end and an outlet Ao, Bo, Co, Do at the opposite end. The system comprises a multi-position valve arrangement 35 which comprises a plurality of ports P1, P2 . . . , Pm, each of which can be connected by a fluid line to one of the other components in the system. Each inlet and outlet of the columns is connectable to an individual one port of the multi-position valve 35 by fluid lines. Valve 35 can be arranged to connect the outlet of any column to the inlet of any other column, e.g. the outlet Ao of column A to the inlet Bi of column B. In this way a fluid in any column can be transferred in series to any other column. The valve is further arranged so that buffer can be provided simultaneously to the inlets of two or more of the other columns and washing fluid to the inlet of the remaining column. This can be achieved by for example valve 35 having a rotor with internal passages which can be rotated in a stator to provide the required connection between ports of the valve.

The system is provided with a sample or other fluid 39 (called “sample” for brevity in the following) containing the target 41 and a syringe or container and pump or a gravity-fed line 42 or other means for feeding the sample to the fluid line or other inlet to a sample-introducing port ‘Psample’ of the valve.

The system further comprises a source of buffer fluid 43 connectable to a buffer inlet port of the valve, a source of washing fluid 45, for example a solution of sodium hydroxide, connectable to a washing fluid inlet port of the valve, a first sensor line comprising a first sensor 47A connectable to an inlet port and a detector outlet port of the valve, a second sensor line comprising a second sensor 47B connectable to an inlet port and a detector outlet port of the valve. The sensors 47A, 47B can be any type of appropriate sensor, for example for the detection of proteins they can be a UV absorption detector sensitive to one UV-light wavelength or, preferably, two or more UV-light wavelengths. Such UV detectors are well known in the art and detect the absorption by proteins of UV light passing through the fluid. In the event that the system is to be used for other purposes, for example desalting, a sensor could be a conductivity sensor of the type well known in the art. Pumps 49A, 49B or other fluid driving means, e.g. gravity, are provided to enable the flow of buffer fluid and washing fluid to the respective ports of the multi-position valve 35. Multi-position valve 35 is further provided with one outlet port which leads to a waste pathway W and a further outlet which leads to a target collecting vessel S or pathway. Control means 51 such as a computer, microprocessor, control circuit with appropriate software, or manually operated control means 51 are provided to control the multi-position valve and pumps in order to achieve the desired flow of sample through the system. It will be appreciated that the system shown in FIG. 3b) illustrates schematically various components, which individually are known, so a detailed description of their construction has not been included here. Further, alternative components which would provide acceptable performance would be apparent to the skilled addressee. For example, the use of a multi-position valve 35 is preferred because that valve arrangement provides a compact valve, but that multi-position valve could be replaced with an array of individually on/off, opened/closed type valves, for example to provide an overall lower cost valve arrangement were the system to be manufactured as disposable hardware. In that case, simple fluid pressure activated membrane valves could be used, or solenoid operated valves could be employed, all with equal effect to the multi-position valve described herein. Such an alternative valve array would be controlled by the control means 51 so that the valves open and close in the correct order to provide the desired flow path(s) described below.

In order to achieve good resolution of the target and to maximize utilization of the chromatography system method are provided comprising at least one separation cycle in accordance with the steps described below which can be carried out manually or by using the control means and appropriate software and hardware to control the pump(s) and valve(s). The methods are intended to ensure that when the columns are used for a plurality of cycles each column is subjected to approximately the same wear, i.e. that each column is utilized equally, and that during the washing step the medium in each column is exposed to the washing fluid for an adequate length of time to ensure enough washing. This is achieved by providing washing fluid to at least one column at the same time as the target is flowing in and/or between two other columns. Switching of the flow between columns is initiated by studying the signal produced by the sensor positioned in the fluid line connecting the outlet from a first column to the inlet of a second column. When the signal indicates that the target has left the first column and sufficient time has elapsed for it to enter the second column, the multi-position valve is activated to connect the inlet of the second column to the supply of buffer and the outlet of the second column to the inlet of the third column in the series. This causes the target to pass through the second column and into the third column. At the same time a wash buffer can be inputted into the first column via its inlet, while the outlet of the first column is connected to waste. This provides the advantage that undesired smaller molecules which have been delayed in the column are directly sent to waste with passing through any subsequent columns, thereby reducing the load on these columns. In one example of the method the target can be separated in a cycle which comprises passing the sample in series through all but one of the plurality of columns, for example, three out of four columns.

The method can be adapted for substantially continuous use, so that as soon as a target from one sample which was initially loaded onto a first column has been separated and collected, the system is ready to be loaded with a new sample onto a column which is not the same as the previous column which initially received the previous sample. Preferably the loading of samples is arranged so that each column in turn initially receives a sample before loading of a sample recommences with the first column. This means that the columns are subjected to approximately the same wear.

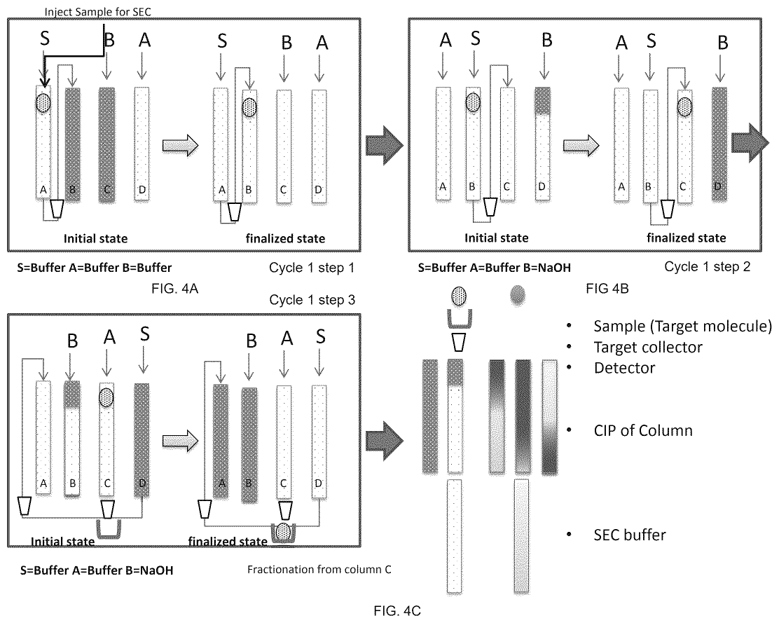

An example of a method for size exclusion chromatography to separate a target from a sample in which samples can be loaded in a series of cycles in which each series comprises four cycles and in each cycle a sample is loaded onto a different column is illustrated in FIGS. 4 to 7. Each cycle comprises three steps.

FIG. 4a) shows the initial and final states of the four columns in the first step of the first cycle. In the initial state of the first step of the first cycle, as shown on the left in FIG. 4a), columns A and D are filled with buffer and columns B and C are filled with washing fluid, for example NaOH. The multi-position valve is arranged so that inlets of columns A, C and D are connected to a flow of buffer, the outlet of column A is connected via a UV-detector to the inlet of column B and the outlets of columns B, C and D are connected to waste. This first step is started by the sample being injected into the flow of buffer entering the inlet of column A. This causes the sample to travel through column A. The detector monitors the fluid exiting column A and when a signal is detected which indicates that the target has passed the detector and has entered column B the first step of the first cycle is completed. This is shown in the finalized state on the right of FIG. 4a). The multi-position valve is then adjusted so that the second step of the first cycle can commence.

In the initial state of the second step of the first cycle, as shown on the left in FIG. 4b), all the columns are filled with buffer. The multi-position valve is arranged so that inlets of columns A and B are connected to a flow of buffer, the inlet of column D is connected to a flow of washing fluid, the outlet of column B is connected via a UV-detector to the inlet of column C and the outlets of columns A, C and D are connected to waste. This second step is started and the flow of buffer entering the inlet of column B causes the target to travel through column B and into column C. The detector monitors the fluid exiting column B and when a signal is detected which indicates that the target has passed the detector and has entered column C the second step of the first cycle is completed. This is shown in the finalized state on the right of FIG. 4b). The multi-position valve is then adjusted so that the third step of the first cycle can commence.

In the initial state of the third and final step of the first cycle, as shown on the left in FIG. 4c), columns A, B, and C are filled with buffer, while column D is filled with washing fluid. The multi-position valve is arranged so that inlets of columns C and D are connected to a flow of buffer, the inlet of column B is connected to a flow of washing fluid, the outlet of column D is connected via a UV-detector to the inlet of column A, the outlets of columns A and B are connected to waste while the outlet of column C is connected via a second detector to an outlet valve (not shown) which can direct the fluid leaving column C to either waste or a container for collecting the target. Initially this outlet valve directs the fluid leaving column C to waste. This third step is started and the flow of buffer entering the inlet of column C causes the target to travel through column C. Once the second detector detects the presence of the target molecule in the fluid leaving column C, the outlet valve is operated to direct the flow to the container for collecting the target and the target is collected. Once the target has been collected step 3 the third step of the first cycle is completed. This is shown in the finalized state on the right of FIG. 4c).

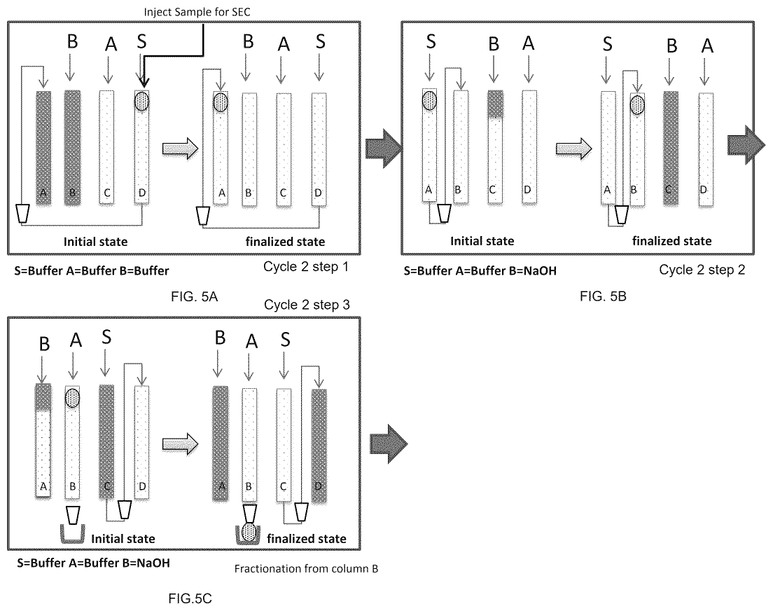

If a further separation is to take place on the system then a second cycle can start. The steps of this cycle are shown in FIGS. 5a) to 5c).

FIG. 5a) shows the initial and final states of the four columns in the first step of the second cycle. In the initial state of the first step of the second cycle, as shown on the left in FIG. 5a), columns C and D are filled with buffer and columns A and B are filled with washing fluid. The multi-position valve is arranged so that inlets of columns B, C and D are connected to a flow of buffer, the outlet of column D is connected via a UV-detector to the inlet of column A and the outlets of columns A, B and C are connected to waste. This first step is started by the sample being injected into the flow of buffer entering the inlet of column D. This causes the sample to travel through column D. The detector monitors the fluid exiting column D and when a signal is detected which indicates that the target has passed the detector and has entered column A the first step of the first cycle is completed. This is shown in the finalized state on the right of FIG. 5a). The multi-position valve is then adjusted so that the second step of the second cycle can commence.

In the initial state of the second step of the second cycle, as shown on the left in FIG. 5b), all the columns are filled with buffer. The multi-position valve is arranged so that inlets of columns A and D are connected to a flow of buffer, the inlet of column C is connected to a flow of washing fluid, the outlet of column A is connected via a UV-detector to the inlet of column B and the outlets of columns B, C and D are connected to waste. This second step is started and the flow of buffer entering the inlet of column A causes the target to travel through column A and into column B. The detector monitors the fluid exiting column A and when a signal is detected which indicates that the target has passed the detector and has entered column B the second step of the second cycle is completed. This is shown in the finalized state on the right of FIG. 5b). The multi-position valve is then adjusted so that the third step of the second cycle can commence.

In the initial state of the third and final step of the second cycle, as shown on the left in FIG. 5c), columns A, B, and D are filled with buffer, while column C is filled with washing fluid. The multi-position valve is arranged so that inlets of columns B and C are connected to a flow of buffer, the inlet of column A is connected to a flow of washing fluid, the outlet of column C is connected via a UV-detector to the inlet of column D, the outlets of columns A and D are connected to waste while the outlet of column B is connected via a second detector to an outlet valve (not shown) which can direct the fluid leaving column B to either waste or a container for collecting the target. Initially this outlet valve directs the fluid leaving column B to waste. This third step is started and the flow of buffer entering the inlet of column B causes the target to travel through column B. Once the second detector detects the presence of the target molecule in the fluid leaving column B, the outlet valve is operated to direct the flow to the container for collecting the target and the target is collected. Once the target has been collected step 3 the third step of the second cycle is completed. This is shown in the finalized state on the right of FIG. 5c).

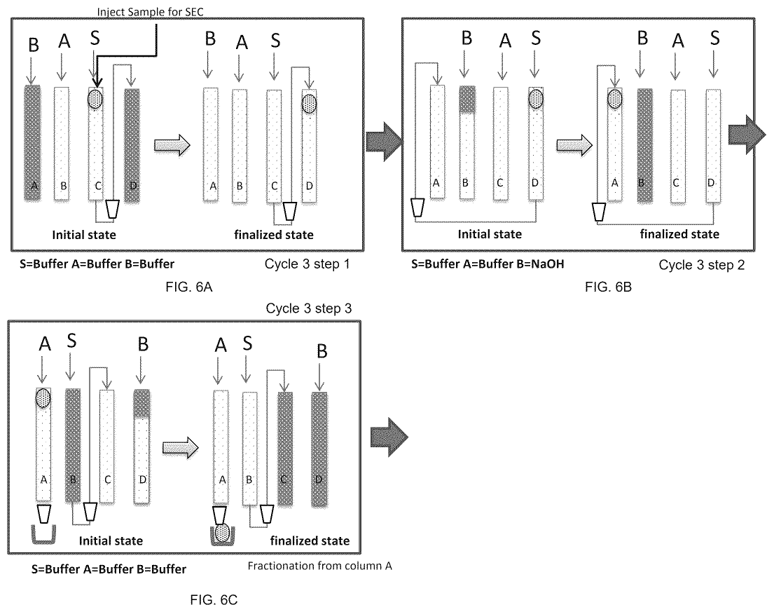

If a further separation is to take place on the system then a third cycle can start. The steps of this cycle are shown in FIGS. 6a) to 6c).

FIG. 6a) shows the initial and final states of the four columns in the first step of the third cycle. In the initial state of the first step of the third cycle, as shown on the left in FIG. 6a), columns B and D are filled with buffer and columns A and D are filled with washing fluid. The multi-position valve is arranged so that inlets of columns A, B, and C are connected to a flow of buffer, the outlet of column C is connected via a UV-detector to the inlet of column D and the outlets of columns A, B and D are connected to waste. This first step is started by the sample being injected into the flow of buffer entering the inlet of column C. This causes the sample to travel through column C. The detector monitors the fluid exiting column C and when a signal is detected which indicates that the target has passed the detector and has entered column D the first step of the first cycle is completed. This is shown in the finalized state on the right of FIG. 6a). The multi-position valve is then adjusted so that the second step of the third cycle can commence.

In the initial state of the second step of the third cycle, as shown on the left in FIG. 6b), all the columns are filled with buffer. The multi-position valve is arranged so that inlets of columns C and D are connected to a flow of buffer, the inlet of column B is connected to a flow of washing fluid, the outlet of column D is connected via a UV-detector to the inlet of column A and the outlets of columns A, B and C are connected to waste. This second step is started and the flow of buffer entering the inlet of column D causes the target to travel through column D and into column A. The detector monitors the fluid exiting column D and when a signal is detected which indicates that the target has passed the detector and has entered column A the second step of the third cycle is completed. This is shown in the finalized state on the right of FIG. 6b). The multi-position valve is then adjusted so that the third step of the third cycle can commence.

In the initial state of the third and final step of the third cycle, as shown on the left in FIG. 6c), columns A, C, and D are filled with buffer, while column B is filled with washing fluid. The multi-position valve is arranged so that inlets of columns A and B are connected to a flow of buffer, the inlet of column D is connected to a flow of washing fluid, the outlet of column B is connected via a UV-detector to the inlet of column C, the outlets of columns C and D are connected to waste while the outlet of column A is connected via a second detector to an outlet valve (not shown) which can direct the fluid leaving column A to either waste or a container for collecting the target. Initially this outlet valve directs the fluid leaving column A to waste. This third step is started and the flow of buffer entering the inlet of column A causes the target to travel through column A. Once the second detector detects the presence of the target molecule in the fluid leaving column A, the outlet valve is operated to direct the flow to the container for collecting the target and the target is collected. Once the target has been collected step 3 the third step of the third cycle is completed. This is shown in the finalized state on the right of FIG. 6c).

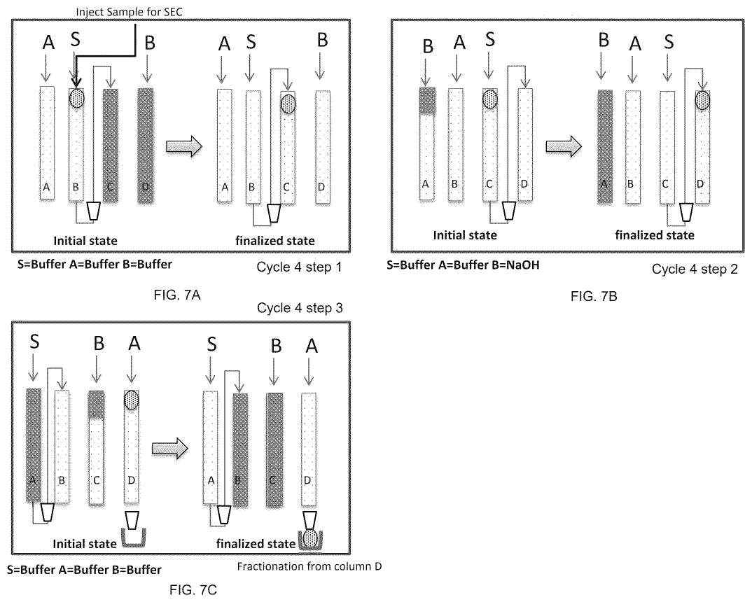

If a further separation is to take place on the system then a fourth cycle can start. The steps of this cycle are shown in FIGS. 7a) to 7c).

FIG. 7a) shows the initial and final states of the four columns in the first step of the fourth cycle. In the initial state of the first step of the fourth cycle, as shown on the left in FIG. 7a), columns A and B are filled with buffer and columns C and D are filled with washing fluid. The multi-position valve is arranged so that inlets of columns A, B, and D are connected to a flow of buffer, the outlet of column B is connected via a UV-detector to the inlet of column C and the outlets of columns A, C and D are connected to waste. This first step is started by the sample being injected into the flow of buffer entering the inlet of column B. This causes the sample to travel through column B. The detector monitors the fluid exiting column B and when a signal is detected which indicates that the target has passed the detector and has entered column C the first step of the first cycle is completed. This is shown in the finalized state on the right of FIG. 7a). The multi-position valve is then adjusted so that the second step of the fourth cycle can commence.

In the initial state of the second step of the fourth cycle, as shown on the left in FIG. 7b), all the columns are filled with buffer. The multi-position valve is arranged so that inlets of columns B and C are connected to a flow of buffer, the inlet of column A is connected to a flow of washing fluid, the outlet of column C is connected via a UV-detector to the inlet of column D and the outlets of columns A, B and D are connected to waste. This second step is started and the flow of buffer entering the inlet of column C causes the target to travel through column C and into column D. The detector monitors the fluid exiting column C and when a signal is detected which indicates that the target has passed the detector and has entered column D the second step of the fourth cycle is completed. This is shown in the finalized state on the right of FIG. 7b). The multi-position valve is then adjusted so that the third step of the fourth cycle can commence.

In the initial state of the third and final step of the fourth cycle, as shown on the left in FIG. 7c), columns B, C, and D are filled with buffer, while column A is filled with washing fluid. The multi-position valve is arranged so that inlets of columns A and D are connected to a flow of buffer, the inlet of column C is connected to a flow of washing fluid, the outlet of column A is connected via a UV-detector to the inlet of column B, the outlets of columns B and C are connected to waste while the outlet of column D is connected via a second detector to an outlet valve (not shown) which can direct the fluid leaving column D to either waste or a container for collecting the target. Initially this outlet valve directs the fluid leaving column D to waste. This third step is started and the flow of buffer entering the inlet of column D causes the target to travel through column D. Once the second detector detects the presence of the target molecule in the fluid leaving column D, the outlet valve is operated to direct the flow to the container for collecting the target and the target is collected. Once the target has been collected step 3 the third step of the fourth cycle is completed. This is shown in the finalized state on the right of FIG. 7c).

During the four cycles each column has been used once for the initial injection of a sample and has been used once for the final fractionation of the target. Thus, the load on each column has been substantially equal.

If a further separation is to take place on the system then a new series of cycles can start. As the contents of the columns in the finalized state of the fourth cycle, namely buffer in columns A and D and washing fluid in columns B and C, is the same as contents of the columns in the initial state of the first cycle, the new series of cycles preferably follow the same order as the previous series of cycles.

In a general method according to the present invention using four chromatography column of which three are to be exposed to a target in a separation cycle, in the first step in the cycle the sample which contains a target, for example proteins, which are to be separated from other molecules in the sample is loaded in a first out of the four columns and subsequently transported to a clean second column while the third and fourth columns are being flushed with a buffer.

Once the target has been detected in the fluid line between the first and second columns and has entered the second column the second step of the cycle commences: the multi-position valve is operated so that the second column is connected in series to a third column and the target is transported to the third column while the first column is flushed with buffer and the fourth column cleaned with the washing solution.

Once the target has been detected in the fluid line between the second and third column and has entered the third column the third step in the cycle commences: the valve is operated so that the fourth column is connected in series to the first column and the washing fluid from column 4 fed into the first column, while the target molecules are transported through the third column. Washing fluid is also fed into the second column. Initially the outlet of the third column is connected via a sensor to the waste. Once the sensor detects the target the output from the sensor is switched to a target collecting vessel and the target is collected there. At the same time the first column is cleaned with washing solution from the fourth column while the third and fourth columns are flushed with buffer.

When further separations are to be performed then each one starts by injection of the sample into the last column which has been filled with buffer after a washing step.

In a second example of a method according to the invention, the target can be separated in a cycle which comprises passing the sample in series through all of the plurality of columns, for example, four out of four columns.

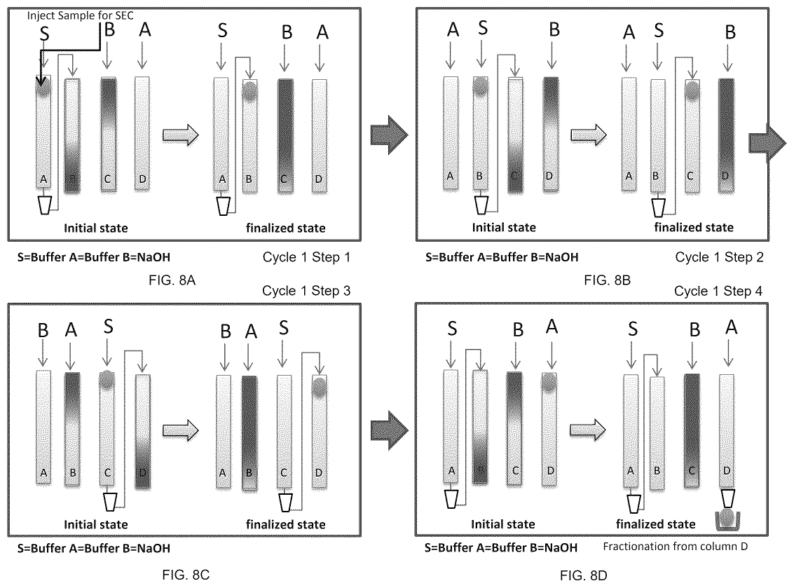

An example of a method for size exclusion chromatography to separate a target from a sample in which samples can be loaded in a series of cycles in which each series comprises four cycles and in each cycle a sample is loaded onto a different column is illustrated in FIGS. 8 to 11. Each cycle uses all four of the columns to achieve high resolution and each cycle comprises four steps.

FIG. 8a) shows the initial and final states of the four columns in the first step of the first cycle. In the initial state of the first step of the first cycle, as shown on the left in FIG. 8a), columns A and D are filled with buffer and column C is being filled with washing fluid, for example NaOH and column B is being flushed with buffer from column A to remove washing fluid. The multi-position valve is arranged so that inlets of columns A and D are connected to a flow of buffer, the inlet of column C is connected to a flow of washing fluid, the outlet of column A is connected via a UV-detector to the inlet of column B and the outlets of columns B, C and D are connected to waste. This first step is started by the sample being injected into the flow of buffer entering the inlet of column A. This causes the sample to travel through column A. The detector monitors the fluid exiting column A and when a signal is detected which indicates that the target has passed the detector and has entered column B the first step of the first cycle is completed. This is shown in the finalized state on the right of FIG. 8a) where column C is now substantially filled with washing fluid. The multi-position valve is then adjusted so that the second step of the first cycle can commence.

Shortly after the initial state of the second step of the first cycle, as shown on the left in FIG. 8b), columns A and B are filled with buffer, column D has started to be filled with washing fluid and column C has started to be emptied of washing fluid. Thus the multi-position valve is arranged so that inlets of columns A and B are connected to a flow of buffer, the inlet of column D is connected to a flow of washing fluid, the outlet of column B is connected via a UV-detector to the inlet of column C and the outlets of columns A, C and D are connected to waste. As this second step progresses the flow of buffer entering the inlet of column B causes the target to travel through column B and into column C. The detector monitors the fluid exiting column B and when a signal is detected which indicates that the target has passed the detector and has entered column C the second step of the first cycle is completed. This is shown in the finalized state on the right of FIG. 8b) where column C is now substantially filled with washing fluid. The multi-position valve is then adjusted so that the third step of the first cycle can commence.

Shortly after the initial state of the third step of the first cycle, as shown on the left in FIG. 8c), columns A and C are filled with buffer, column B has started to be filled with washing fluid while column D, which was filled with washing fluid, is being flushed with the contents from column C. The multi-position valve is arranged so that inlets of columns A and C are connected to a flow of buffer, the inlet of column B is connected to a flow of washing fluid, the outlet of column C is connected via a UV-detector to the inlet of column D, the outlets of columns A, B and D are connected to waste. The detector monitors the fluid exiting column C and when a signal is detected which indicates that the target has passed the detector and has entered column D the third step of the first cycle is completed. This is shown in the finalized state on the right of FIG. 8c) where column B is now substantially filled with washing fluid. The multi-position valve is then adjusted so that the fourth step of the first cycle can commence.

Shortly after the initial state of the fourth step of the first cycle, as shown on the left in FIG. 8d), columns A, and D are filled with buffer, while column B which was filled with washing fluid is being flushed with buffer and column C is being filled with washing fluid. The multi-position valve is arranged so that inlets of columns A and D are connected to a flow of buffer, the inlet of column C is connected to a flow of washing fluid, the outlet of column A is connected via a UV-detector to the inlet of column B, the outlets of columns B and C are connected to waste. while the outlet of column D is connected via a second detector to an outlet valve (not shown) which can direct the fluid leaving column D to either waste or a container for collecting the target. Initially this outlet valve directs the fluid leaving column D to waste. Once this step is started the flow of buffer entering the inlet of column D causes the target to travel through column D. Once the second detector detects the presence of the target molecule in the fluid leaving column D, the outlet valve is operated to direct the flow to the container for collecting the target and the target is collected. Once the target has been collected the fourth step of the first cycle is completed. This is shown in the finalized state on the right of FIG. 8d) where column C is now substantially filled with washing fluid.

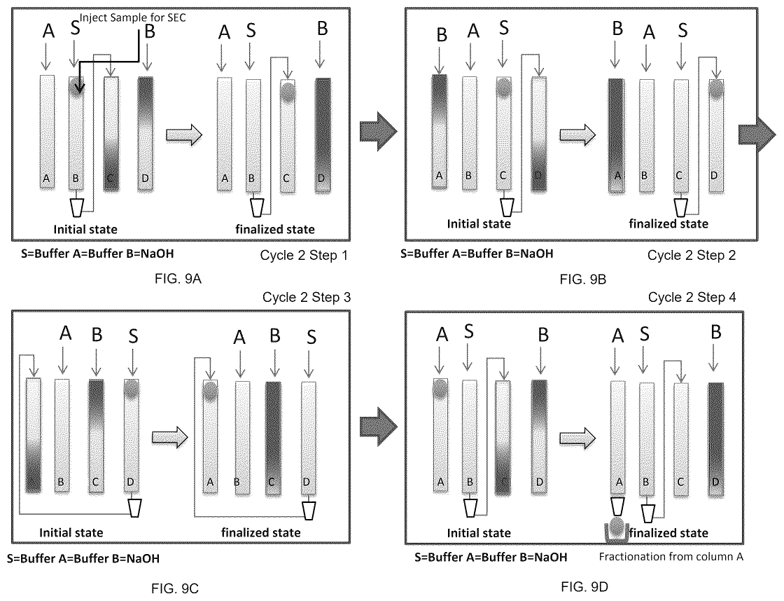

If a further separation is to take place on the system then a second cycle can start. The steps of this cycle are shown in FIGS. 9a) to 9d).

FIG. 9a) shows the initial and final states of the four columns in the first step of the second cycle. The multi-position valve is arranged so that inlets of columns A and B are connected to a flow of buffer, column D is connected to a flow of washing fluid, the outlet of column B is connected via a UV-detector to the inlet of column C and the outlets of columns A, C and D are connected to waste. After starting the first step of the second cycle, as shown on the left in FIG. 9a), columns A and B are filled with buffer, column D which was full of buffer is being filled with washing fluid and column C which was filled with washing fluid is being filled with buffer. This first step is started by the sample being injected into the flow of buffer entering the inlet of column B. This causes the sample to travel through column B. The detector monitors the fluid exiting column B and when a signal is detected which indicates that the target has passed the detector and has entered column C the first step of the first cycle is completed. This is shown in the finalized state on the right of FIG. 9a). Columns A, B and C contain buffer and column D contains washing fluid. The multi-position valve is then adjusted so that the second step of the second cycle can commence.

In the second step of the second cycle shown in FIG. 9b) the multi-position valve is arranged so that inlets of columns B and C are connected to a flow of buffer, the inlet of column A is connected to a flow of washing fluid, the outlet of column C is connected via a UV-detector to the inlet of column D and the outlets of columns A, B and D are connected to waste. This second step is started and the flow of buffer entering the inlet of column C causes the target to travel through column C and into column D. After the second step of the second cycle has commenced, as shown on the left in FIG. 9b), columns B and C are filled with buffer, column D is being flushed of washing fluid and column A is being filled with washing fluid. The detector monitors the fluid exiting column C and when a signal is detected which indicates that the target has passed the detector and has entered column D the second step of the second cycle is completed. This is shown in the finalized state on the right of FIG. 9b). Columns B, C and D contain buffer and column A contains washing fluid. The multi-position valve is then adjusted so that the third step of the second cycle can commence.

In the third step of the second cycle, as shown in FIG. 9c), the multi-position valve is arranged so that inlets of columns B and D are connected to a flow of buffer, the inlet of column C is connected to a flow of washing fluid, the outlet of column D is connected via a UV-detector to the inlet of column A, the outlets of columns A,B and C are connected to waste. At the start of the step columns B, C and D are filled with buffer, while column C is filled with washing fluid. As shown on the left in FIG. 9c) once this third step is started the flow of buffer entering the inlet of column D causes the target to travel through column D. The detector monitors the fluid exiting column D and when a signal is detected which indicates that the target has passed the detector and has entered column A the third step of the second cycle is completed. This is shown in the finalized state on the right of FIG. 9c). Columns A, B, and D contain buffer, column C contains washing fluid and the target is in column A. The multi-position valve is then adjusted so that the fourth step of the second cycle can commence

In the fourth step of the second cycle, as shown in FIG. 9d), the multi-position valve is arranged so that inlets of columns A and B are connected to a flow of buffer, the inlet of column D is connected to a flow of washing fluid, the outlet of column B is connected via a UV-detector to the inlet of column C, the outlets of columns B and D are connected to waste and the outlet of column B is connected via a second detector to an outlet valve (not shown) which can direct the fluid leaving column B to either waste or a container for collecting the target. Initially this outlet valve directs the fluid leaving column B to waste. Once this step is started the flow of buffer entering the inlet of column B causes the target to travel through column B. Once the second detector detects the presence of the target molecule in the fluid leaving column B, the outlet valve is operated to direct the flow to the container for collecting the target and the target is collected. Once the target has been collected the fourth step of the first cycle is completed. At the start of the step columns A, B, and Dare filled with buffer, while column C is filled with washing fluid. As shown on the left in FIG. 9d) once this fourth step has started the flow of buffer entering the inlet of column A causes the target to travel through column A. Once the second detector detects the presence of the target molecule in the fluid leaving column A, the outlet valve is operated to direct the flow to the container for collecting the target and the target is collected. Once the target has been collected the fourth step of the second cycle is completed. This is shown in the finalized state on the right of FIG. 9d where columns A, B, and C contain buffer and column D contains washing fluid.

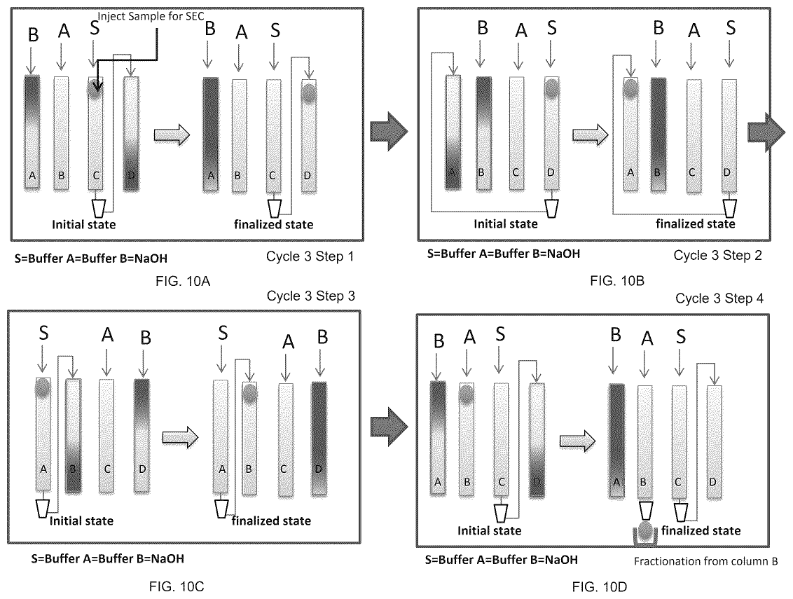

If a further separation is to take place on the system then a third cycle can start. The steps of this cycle are shown in FIGS. 10a) to 10c). FIG. 10a) shows the intermediate and final states of the four columns in the first step of the third cycle. The multi-position valve is arranged so that inlets of columns B and C are connected to a flow of buffer, column A is connected to a flow of washing fluid, the outlet of column C is connected via a UV-detector to the inlet of column D and the outlets of columns A, B and D are connected to waste. After starting the first step of the third cycle, as shown on the left in FIG. 10a), columns B and C are filled with buffer, column A which was full of buffer is being filled with washing fluid and column D which was filled with washing fluid is being filled with buffer. This first step is started by the sample being injected into the flow of buffer entering the inlet of column C. This causes the sample to travel through column C. The detector monitors the fluid exiting column C and when a signal is detected which indicates that the target has passed the detector and has entered column D the first step of the first cycle is completed. This is shown in the finalized state on the right of FIG. 10a). Columns B, C and D contain buffer and column A contains washing fluid. The multi-position valve is then adjusted so that the second step of the third cycle can commence.

In the second step of the third cycle the multi-position valve is arranged so that inlets of columns C and D are connected to a flow of buffer, the inlet of column B is connected to a flow of washing fluid, the outlet of column D is connected via a UV-detector to the inlet of column A and the outlets of columns A, B and C are connected to waste. This second step is started and the flow of buffer entering the inlet of column D causes the target to travel through column D and into column A. After the second step of the third cycle has commenced, as shown on the left in FIG. 10b), columns C and D are being filled with buffer and column B is being filled with washing fluid. The detector monitors the fluid exiting column D and when a signal is detected which indicates that the target has passed the detector and has entered column A the second step of the third cycle is completed. This is shown in the finalized state on the right of FIG. 10b) where column B is filled of washing fluid, the other columns contain buffer and the target is in column A. The multi-position valve is then adjusted so that the third step of the third cycle can commence.

In the third step of the third cycle, as shown in FIG. 10c), the multi-position valve is arranged so that inlets of columns A and C are connected to a flow of buffer, the inlet of column D is connected to a flow of washing fluid, the outlet of column A is connected via a UV-detector to the inlet of column B, the outlets of columns B, C and D are connected to waste. At the start of the step columns A, C and D are filled with buffer, while column B is filled with washing fluid. As shown on the left in FIG. 10c) once this third step is started the flow of buffer entering the inlet of column A causes the target to travel through column A. The detector monitors the fluid exiting column A and when a signal is detected which indicates that the target has passed the detector and has entered column B the third step of the third cycle is completed. The starting state of the columns for fourth step is shown in the finalized state on the right of FIG. 10c) with the target in column B. The multi-position valve is then adjusted so that the fourth step of the third cycle can commence

At the start of the fourth step columns A, B, and C are filled with buffer, while column D is filled with washing fluid. In the fourth step of the third cycle, as shown in FIG. 10d), the multi-position valve is arranged so that inlets of columns B and C are connected to a flow of buffer, the inlet of column A is connected to a flow of washing fluid, the outlet of column C is connected via a UV-detector to the inlet of column D, the outlets of columns A and D are connected to waste and the outlet of column B is connected via a second detector to an outlet valve (not shown) which can direct the fluid leaving column B to either waste or a container for collecting the target. Initially this outlet valve directs the fluid leaving column B to waste. Once this step is started the flow of buffer entering the inlet of column B causes the target to travel through column B. Once the second detector detects the presence of the target molecule in the fluid leaving column B, the outlet valve is operated to direct the flow to the container for collecting the target and the target is collected. Once the target has been collected the fourth step of the first cycle is completed. This is shown in the finalized state on the right of FIG. 10d).

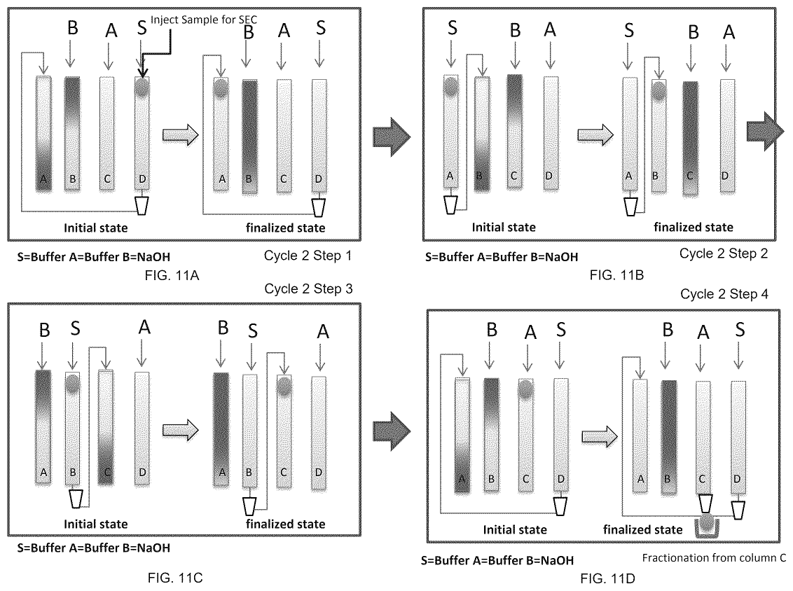

If a further separation is to take place on the system then a fourth cycle can start. The steps of this cycle are shown in FIGS. 11a) to 11d). FIG. 11a) shows the intermediate and final states of the four columns in the first step of the fourth cycle. Initially columns B, C and D are filled with buffer and column A is filled with washing fluid. The multi-position valve is arranged so that inlets of columns C and D are connected to a flow of buffer, column B is connected to a flow of washing fluid, the outlet of column D is connected via a UV-detector to the inlet of column A and the outlets of columns B, C and D are connected to waste. This first step is started by the sample being injected into the flow of buffer entering the inlet of column D. This causes the sample to travel through column D. After starting the first step of the third cycle, as shown on the left in FIG. 11a), columns C and D are filled with buffer, column A which was full of washing fluid is being filled with buffer and column B which was filled with buffer is being filled with washing fluid. The detector monitors the fluid exiting column D and when a signal is detected which indicates that the target has passed the detector and has entered column A the first step of the first cycle is completed. This is shown in the finalized state on the right of FIG. 11a). Columns A, C and D contain buffer and column B contains washing fluid. The target is in column A. The multi-position valve is then adjusted so that the second step of the fourth cycle can commence.

In the second step the multi-position valve is arranged so that inlets of columns A and D are connected to a flow of buffer, the inlet of column C is connected to a flow of washing fluid, the outlet of column A is connected via a UV-detector to the inlet of column B and the outlets of columns B, C and D are connected to waste. This second step is started and the flow of buffer entering the inlet of column A causes the target to travel through column A and into column B. After the second step of the third cycle has commenced, as shown on the left in FIG. 11b), columns A and D are being filled with buffer and column C is being filled with washing fluid. The detector monitors the fluid exiting column A and when a signal is detected which indicates that the target has passed the detector and has entered column B the second step of the fourth cycle is completed. This is shown in the finalized state on the right of FIG. 11b) with the target in column B, buffer in columns A and D, and washing fluid in column C. The multi-position valve is then adjusted so that the third step of the fourth cycle can commence.

In the third step of the fourth cycle, as shown in FIG. 11c), the multi-position valve is arranged so that inlets of columns B and D are connected to a flow of buffer, the inlet of column A is connected to a flow of washing fluid, the outlet of column B is connected via a UV-detector to the inlet of column C, the outlets of columns B, C and D are connected to waste. At the start of the step columns A, B and D are filled with buffer, while column C is filled with washing fluid. As shown on the left in FIG. 11c) once this third step is started the flow of buffer entering the inlet of column B causes the target to travel through column B. The detector monitors the fluid exiting column B and when a signal is detected which indicates that the target has passed the detector and has entered column C the third step of the fourth cycle is completed. The starting state of the columns for fourth step is shown in the finalized state on the right of FIG. 11c) where the target is in column C. The multi-position valve is then adjusted so that the fourth step of the fourth cycle can commence

At the start of the fourth step columns B, C, and D are filled with buffer, while column A is filled with washing fluid. In the fourth step of the fourth cycle, as shown in FIG. 11d), the multi-position valve is arranged so that inlets of columns C and D are connected to a flow of buffer, the inlet of column B is connected to a flow of washing fluid, the outlet of column D is connected via a UV-detector to the inlet of column A, the outlets of columns A and B are connected to waste and the outlet of column C is connected via a second detector to an outlet valve (not shown) which can direct the fluid leaving column C to either waste or a container for collecting the target. Initially this outlet valve directs the fluid leaving column C to waste. Once this step is started the flow of buffer entering the inlet of column C causes the target to travel through column C. Once the second detector detects the presence of the target molecule in the fluid leaving column C, the outlet valve is operated to direct the flow to the container for collecting the target and the target is collected. Once the target has been collected the fourth step of the fourth cycle is completed. This is shown in the finalized state on the right of FIG. 11d).

If a further separation is to take place on the system then a new series of cycles can start. As the contents of the columns in the finalized state of the fourth cycle, namely buffer in columns A, B and C and washing fluid in column D, is the same as contents of the columns in the initial state of the first cycle, the new series of cycles preferably follow the same order as the previous series of cycles.

If four SEC or desalting cycles are performed in the order described above then each column has been used once for the initial injection of a sample and each column has been used once for the final fractionation of the target. Thus, the load on each column has been substantially equal over the four cycles. Thus in each set of four cycles using four columns the designation of each column can be considered to have been decreased by one in base four each time a new cycle starts, such that when starting the next cycle the second column (i.e. column B) is re-designated the first column (i.e. column A), the third column (column C) is re-designated the second column (column B), the fourth column (column D) is re-designated the third column (column C) and the first column (column A) is re-designated the fourth column (column D).

Thus, when N columns are used, then in each subsequent cycle in set of N cycles the designation of a column is decreased by one in base N. For example, in a system which uses three columns, N=3 and at the end of the first cycle column 1 is re-designated column 3, column 2 is re-designated column 1 and column 3 is re-designated column 2.

In a system with three columns (N=3) it is possible to use just two (N−1) of the columns for the SEC or desalting in which case each cycle has only two steps, namely a first step of passing the sample through the first column to a second column while washing the third column and a second step of collecting the target from the second column while flushing the third column with buffer and filling the first column with the washing fluid from the third column.

In a system with three columns (N=3) it is possible to use all three (N) of the columns for the SEC or desalting in which case each cycle has three steps, namely a first step of passing the sample through the first column to a second column while washing the third column, a second step of transporting the target from the second column to the third column while flushing the first column with washing fluid, and a third step of collecting the target from the third column when filling the second column with the washing fluid from the first column. A new cycle can then start from the first column. However, if the load on the columns is to be equalized then the next cycle should start with loading onto the second column. Preferably, in order to reduce the risk of the target coming into contact with the washing fluid in the second column, the loading of the sample should be delayed until after a suitable fraction, for example 20% or 25% or 50% or even more, of a column volume of buffer, has been passed into the second column.

In order to equalize the load on the columns it is of course possible to change the order of the columns by increasing or decreasing the designation of each column by any number which is lower than N as long as the steps of the cycles are amended correspondingly in order to ensure washing of a column is achieved between targets from two different samples entering the column.

One method in accordance with the present invention for performing size exclusion chromatography separation (SEC) or desalting of a target from a sample in a system comprises the following steps:
i) the step of providing a system with at least three columns (A, B, C, . . . ) that are connectable, for example, with only one pair of the columns in series at the same time;
ii) the step of connecting in series a column containing the target with another column,
iii) the step of washing at least one further column with a washing fluid at the same time as the target is being transported by a flow of buffer from said column containing the target to said another column.

An additional step of the method comprises connecting the outlet of said another column to the inlet of the washed further column and subsequently collecting the target from the outlet of the washed column.

Alternative additional steps of the method comprise the steps of transporting the target in series from the outlet of said another column in any order through said washed further column and one or more additional columns, and finally collecting the target from the last additional column or the washed further column.

An example of a method in accordance with the invention for a size exclusion chromatography (SEC) or desalting system comprising four columns for separating a target from a sample, wherein the target passes through four columns before being collected, comprises the steps of:
a) i) positioning the valve such that the inlet of a third column is connected to a supply of washing fluid, the outlet of a first column is connected to the inlet of a second column, the inlet of the first column and optionally the inlet of the fourth column is connected to the supply of said first buffer and the outlets of said second, third and fourth columns are directed to a waste arrangement,
iv) arranging a detector between the outlet of the first column and the inlet of the second column,
v) injecting a sample S containing said target substance into the inlet of said first column;
vi) subsequently pumping washing fluid into said third column and pumping first buffer into the inlet of at least said first column and optionally said fourth column, until the target molecule has passed said detector and entered the second column;
b) i) positioning the valve such that the outlet of said second column is connected to the inlet of said third column, the inlet of the second column and optionally the inlet of said first column is connected to the supply of said first buffer, the inlet of the fourth column is connected to the supply of washing fluid,
ii) arranging said detector between the outlet of the second column and the inlet of the third column,
iii) subsequently pumping washing fluid into said fourth column while pumping first buffer into at least the inlet of said second column until the target molecule has passed said detector and entered the third column;
c) i) connecting the outlet of said third column to the inlet of said fourth column, the inlet of the third column and optionally the inlet said second column is connected to the supply of said first buffer, the inlet of the first column is connected to the supply of washing fluid,
ii) arranging said detector between the outlet of the third column and the inlet of the fourth column,
iii) subsequently pumping washing fluid into said first column while pumping first buffer into at least the inlet of said third column until the target molecule has passed said detector and entered the fourth column,
d) i) connecting the outlet of said fourth column to valve means for diverting fluid to a waste arrangement or a target collection arrangement, the inlet of said third column is connected to the supply of washing fluid, the outlet of said first column is connected to the inlet of said second column, and the outlets of the second column and third column are connected to the waste arrangement;
ii) arranging said first detector between the outlet of said first column and the inlet of said second column, and arranging said second detector between the outlet of the fourth column and the inlet of the collection arrangement,
iii) pumping washing fluid into said third column and first buffer into the inlet of at least the fourth columns until the target molecule has passed said detector and entered the collection arrangement.

In all examples of methods according to the invention if it is determined that washing between each injection of a sample is not necessary, for example that it is possible to run a plurality of samples before washing the columns, then the methods can be provided with steps in which the washing fluid is replaced by buffer fluid or indeed no fluid at all,

The above description of the present disclosure is provided for the purpose of illustration, and it would be understood by those skilled in the art that various changes and modifications may be made without changing the concept and essential features of the present disclosure. Thus, it is clear that the above-described embodiments are illustrative in all aspects and do not limit the present disclosure.

The scope of the present disclosure is defined by the following claims rather than by the detailed description of the embodiment. It shall be understood that all modifications and embodiments conceived from the meaning and scope of the claims and their equivalents are included in the scope of the present disclosure.

1. A method for performing size exclusion chromatography separation (SEC) or desalting of a target from a sample in a system comprising at least three columns (A, B, C, . . . ) at least two of which are connectable in series at the same time, wherein a cycle comprises:
i) a first step of passing the sample through the first column to a second column while washing the third column;
ii) a second step of transporting the target from the second column to the third column while flushing the first column with washing fluid,
ii) a third step of collecting the target from the third column when filling the second column with the washing fluid from the first column;
wherein after at least three cycles, each column has been used once for an initial injection of a sample and each column has been used once for a final fractionation of the target.

2. A method according to claim 1 further comprising the subsequent step of connecting the outlet of said another column to the inlet of the washed further column and subsequently collecting the target from the outlet of the washed column.

3. A method according to claim 1 further comprising the steps of transporting the target in series from the outlet of said another column in any order through said washed further column and one or more additional columns, and finally collecting the target from the last additional column or the washed further column.

4. A method according to claim 1, the system comprising four columns, wherein after four cycles, each column has been used once for an initial injection of a sample and each column has been used once for a final fractionation of the target.

5. A method according to claim 1, for a size exclusion chromatography (SEC) or desalting system wherein said at least three columns comprise four columns for separating a target from a sample, wherein the target passes through three or four columns before being collected, wherein each column has an inlet and an outlet fluidly connectable to a valve arrangement for selectively simultaneously connecting said at least two chromatography columns in series and one of the other chromatography columns to flow of washing fluid, wherein said valve arrangement comprises a first inlet for inputting a buffer solution, a second inlet for inputting a washing fluid, an inlet for receiving fluid from said chromatography columns, and a first outlet leading to valve means for diverting fluid to a waste arrangement or a target collection arrangement;
the system further comprising:
a first detector for detecting the presence of the target substance;
a second detector for detecting the presence of the target substance;
one or more pumps for pumping buffer and washing fluid;
a supply of a first buffer solution;
a supply of said washing fluid; and,
a means for injecting a sample into a SEC column.

6. The method according to claim 5, further comprising the steps of:
a) i) operating the valve arrangement such that the inlet of a third column is connected to a supply of washing fluid, the outlet of a first column is connected to the inlet of a second column, the inlet of the first column and optionally the inlet of the fourth column is connected to the supply of said first buffer and the outlets of said second, third and fourth columns are directed to a waste arrangement,
ii) arranging said detector between the outlet of the first column and the inlet of the second column,
iii) injecting a sample S containing said target substance into the inlet of said first column;
iv) subsequently pumping washing fluid into said third column and pumping first buffer into the inlet of at least said first column and optionally said fourth column, until the target molecule has passed said detector and entered the second column;
b) i) operating the valve arrangement such that the outlet of said second column is connected to the inlet of said third column, the inlet of the second column and optionally the inlet of said first column is connected to the supply of said first buffer, the inlet of the fourth column is connected to the supply of washing fluid,
ii) arranging said detector between the outlet of the second column and the inlet of the third column,
iii) subsequently pumping washing fluid into said fourth column while pumping first buffer into at least the inlet of said second column until the target molecule has passed said detector and entered the third column;
c) i) operating the valve arrangement such that the outlet of said third column is connected to the inlet of said fourth column, the inlet of the third column and optionally the inlet said second column is connected to the supply of said first buffer, the inlet of the first column is connected to the supply of washing fluid,
ii) arranging said detector between the outlet of the third column and the inlet of the fourth column,
iii) subsequently pumping washing fluid into said first column while pumping first buffer into at least the inlet of said third column until the target molecule has passed said detector and entered the fourth column,
d) i) operating the valve arrangement such that the outlet of said fourth column is connected to valve means for diverting fluid to a waste arrangement or a target collection arrangement, the inlet of said third column is connected to the supply of washing fluid, the outlet of said first column is connected to the inlet of said second column, and the outlets of the second column and third column are connected to the waste arrangement;
ii) arranging said first detector between the outlet of said first column and the inlet of said second column, and arranging said second detector between the outlet of the fourth column and the inlet of the collection arrangement,
iii) pumping washing fluid into said third column and first buffer into the inlet of at least the fourth columns until the target molecule has passed said detector and entered the collection arrangement.

7. The method according to claim 1, for a size exclusion chromatography (SEC) or desalting system comprising four columns for separating a target from a sample, wherein the target passes through three columns before being collected, wherein each column has an inlet and an outlet, and is fluidly connectable to a valve arrangement, for example a multi-position valve, arranged for selectively simultaneously connecting only two of said chromatography columns in series and one of the other chromatography columns to flow of washing fluid, wherein said valve comprises a first inlet port for inputting a buffer solution, a second inlet port for inputting a washing fluid, inlet port for receiving fluid from said chromatography columns, a first outlet port leading to valve means for diverting fluid to a waste arrangement or a target collection arrangement;
the system further comprising
a first detector for detecting the presence of the target substance,
a second detector for detecting the presence of the target substance
a plurality of pumps for pumping buffer and washing fluid;
a supply of a first buffer solution;
a supply of said washing fluid; and,
a means for injecting a sample into a SEC column,
wherein the method comprises the steps of:
a) i) positioning the valve arrangement such that the inlet of a third column is connected to a supply of washing fluid, the outlet of a first column is connected to the inlet of a second column, the inlet of the first column and optionally the inlet of the fourth column is connected to the supply of said first buffer and the outlets of said second, third and fourth columns are directed to a waste arrangement,
ii) arranging said detector between the outlet of the first column and the inlet of the second column,
iii) injecting a sample S containing said target substance into the inlet of said first column;
iv) subsequently pumping washing fluid into said third column and pumping first buffer into the inlet of at least said first column and optionally said fourth column, until the target molecule has passed said detector and entered the second column;
b) i) positioning the valve such that the outlet of said second column is connected to the inlet of said third column, the inlet of the second column and optionally the inlet of said first column is connected to the supply of said first buffer, the inlet of the fourth column is connected to the supply of washing fluid,
ii) arranging said detector between the outlet of the second column and the inlet of the third column,
iii) subsequently pumping washing fluid into said fourth column while pumping first buffer into at least the inlet of said second column until the target molecule has passed said detector and entered the third column;
c) i) positioning the valve such that the outlet of said third column is connected to valve means for diverting fluid to a waste arrangement or a target collection arrangement, the inlet of said third column is connected to the supply of buffer, the outlet of said fourth column is connected to the inlet of said first column, and the outlets of the first column and second column are connected to the waste arrangement;
ii) arranging said first detector between the outlet of said fourth column and the inlet of said first column, and arranging said second detector between the outlet of the third column and the inlet of the collection arrangement;
iii) pumping washing fluid into said second column and first buffer into the inlet of at least the third column until the target molecule has passed said detector and entered the collection arrangement.

8. The method according to claim 6, comprising the step of:
repeating steps of the method wherein in each repetition the designation of each column is decreased by one in base four, such that the second column is re-designated the first column, the first column is re-designated the fourth column, the third column is re-designated the second column and the fourth column is re-designated the third column.

9. The method according to claim 1, wherein the flow rate into each column is controlled to be substantially identical.

10-12. (canceled)
